(19) United States
(12) Patent Application Publication
(10) Pub. No.: US 2021/0394790 A1
(43) Pub. Date: Dec. 23, 2021

(54) IMU FAULT MONITORING METHOD AND APPARATUS FOR MULTIPLE IMUS/GNSS INTEGRATED NAVIGATION SYSTEM

(71) Applicant: Korea Advanced Institute of Science and Technology, Daejeon (KR)

(72) Inventors: Jiyun Lee, Daejeon (KR); Jinsil Lee, Daejeon (KR); Dongwoo Kim, Daejeon (KR); Dongchan Min, Daejeon (KR); Gihun Nam, Daejeon (KR)

(21) Appl. No.: 17/351,297

(22) Filed: Jun. 18, 2021

(30) Foreign Application Priority Data
Jun. 19, 2020 (KR) 10-2020-0075298

(51) Int. Cl. B60W 60/00; B60W 50/02; G01S 19/47

(52) U.S. Cl. CPC B60W 60/0015; B60W 2050/0215; G01S 19/47; B60W 50/0205

(57) ABSTRACT

An IMU sensor fault detection method and apparatus for a multiple IMUs and GNSS integrated navigation system is disclosed. The method is based on a decentralized Kalman filter. In a navigation system in which multiple IMU sensors and GNSS sensors are integrated, a fault of an IMU sensor is detected through correlation analysis between fault detection test statistics of each sub-filter consisting of each IMU sensor.

An IMU sensor fault can be detected and meet the navigation continuity probability requirement required by the system to support the operation of high-safety autonomous vehicles. By considering the correlation between the sub-filters, the continuity requirement assigned to each sub-filter is relaxed, and the relaxed continuity requirement has a direct effect on the improvement of the navigation system availability, contributing to the increase of the system availability.

### BACKGROUND OF THE INVENTION

### 1. Field of the Invention

The present invention relates to a method and apparatus for detecting a fault of an IMU sensor for a multiple Inertial Measurement Units (IMUs) and Global Navigation Satellite System (GNSS) integrated navigation system, and more particularly, to a method and apparatus for detecting, in a navigation system that integrates multiple IMU sensors and GNSS sensor based on a decentralized Kalman filter, a fault of an IMU sensor through correlation analysis between fault detection test statistics of each sub-filter including a IMU sensor.

### 2. Description of the Related Art

The multiple IMUs and GNSS integrated navigation system 100 (see FIG. 1) to which the method and apparatus for detecting a fault of an IMU sensor according to the present invention is applied is based on a Kalman filter (KF). In the multiple IMUs and GNSS integrated navigation system 100, the Kalman filter predicts a navigation solution using the IMU sensor measurement and updates the navigation solution through the GNSS sensor measurement. Here, the navigation solution refers to current location information calculated for an aircraft or the like. In the multiple IMUs/GNSS integrated navigation system 100, such a navigation solution prediction and update process is performed by each sub-filter, and the synthesis filter 110 integrates the navigation solutions calculated from each sub-filter to calculate the final navigation solution.

### SUMMARY OF THE INVENTION

The present invention detects IMU sensor failure, meets the navigation continuity probability requirements required by the system to support the operation of a high-safety autonomous vehicle, and allows the continuity requirements assigned to each sub-filter to be relaxed by taking into account correlations between sub-filters, thereby is to provide a method and apparatus for detecting a fault of an IMU sensor for the multiple IMUs and GNSS integrated navigation system.

According to an aspect of the present invention, there is provided a method for detecting for a fault of an IMU sensor for a multiple Inertial Measurement Units (IMUs) and Global Navigation Satellite System (GNSS) integrated navigation system, comprising the steps of: (a) receiving values to be used as an input to the Kalman filter (hereinafter, ‘KF input value’) from the GNSS and the multiple IMUs; (b) inputting the KF input value to each sub-filter of a decentralized Kalman filter; (c) calculating test statistics for fault detection in said each sub-filter; (d) calculating correlation between the test statistics; (e) based on the correlation calculated in the step (d), determining each fault monitor threshold that can match navigation continuity requirements; and (f) detecting IMU sensor fault by comparing the threshold with the test statistics.

According to other aspect of the present invention, there is provided an apparatus for detecting for a fault of an IMU sensor for a multiple Inertial Measurement Units (IMUs) and Global Navigation Satellite System (GNSS) integrated navigation system, comprising: at least one processor; and, at least one memory storing computer-executable instructions, wherein the computer-executable instructions stored in said at least one memory, when executed by the at least one processor, causes the at least one processor to perform operations comprising: (a) receiving values to be used as an input to the Kalman filter (hereinafter, ‘KF input value’) from sensors; (b) inputting the KF input value to each sub-filter of a decentralized Kalman filter; (c) calculating test statistics for fault detection in said each sub-filter; (d) calculating correlation between the test statistics; (e) based on the correlation calculated in the step (d), determining each fault monitor threshold that can match navigation continuity requirements; and (f) detecting IMU sensor fault by comparing the threshold with the test statistics.

According to the present invention, a method and apparatus for detecting a fault of an IMU sensor for the multiple IMUs and GNSS integrated navigation system is provided, which can detect IMU sensor fault and meet the navigation continuity probability requirements required by the system to support the operation of high-safety autonomous vehicles. By considering the correlation between the sub-filters, the continuity requirements assigned to each sub-filter is relaxed, and the relaxation of continuity requirements has a direct effect on the improvement of the navigation system availability and contributes to the increase of the system availability.

### BRIEF DESCRIPTION OF THE DRAWINGS

FIG. 1 is a block diagram showing the configuration of a decentralized Kalman filter (KF)-based multiple IMUs/GNSS integrated navigation system.

FIG. 2 is a flow chart of a method for detecting a fault of an IMU sensor for the multiple IMUs/GNSS integrated navigation system.

FIG. 3 is a view for explaining the variables of the test statistics used for IMU sensor fault detection of the present invention.

FIG. 4 is a schematic diagram showing test statistics for a plurality of sub-filters composed of multiple IMU sensors and a plurality of GNSS pseudorange measurements within a decentralized Kalman filter.

FIG. 5 is a diagram for explaining the definition of a continuity risk probability and a threshold value;

FIG. 6 is a view for explaining a method of determining a threshold value in each sub-filter to ensure continuity risk probability.

FIG. 7 is a diagram showing the continuity requirements assigned to each sub-filter when correlation is not taken into account.

FIG. 8 is a diagram showing the continuity requirements assigned to each sub-filter when correlation is considered.

### DETAILED DESCRIPTION OF THE INVENTION

Hereinafter, preferred embodiments of the present invention will be described in detail with reference to the accompanying drawings. The terms or words used in the present specification and claims should not be construed as being limited to conventional or dictionary meanings and, based on the principle that the inventor can appropriately define the concept of a term in order to explain his invention in the best way, it should be interpreted as a meaning and concept consistent with the technical idea of the present invention. The embodiments described in the present specification and the configurations shown in the drawings are only the preferred embodiments of the present invention and do not represent all of the technical spirit of the present invention and, therefore, it should be understood that there may be various equivalents and variations at the time of the present application.

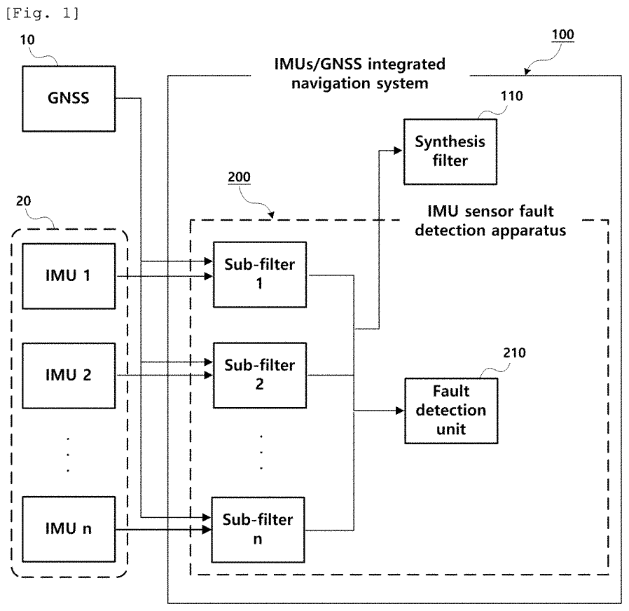

FIG. 1 is a block diagram showing the configuration of a decentralized KF-based multiple IMUs/GNSS integrated navigation system 100.

As described above, the multiple IMUs/GNSS integrated navigation system 100 to which the method and apparatus for detecting a fault of an IMU sensor of the present invention is applied is based on a Kalman filter. In the multiple IMUs/GNSS integrated navigation system 100, the Kalman filter predicts the navigation solution using the IMU sensor measurements and updates the navigation solution through the GNSS sensor measurements. Here, the navigation solution refers to current location information calculated for an aircraft or the like. In the multiple IMUs/GNSS integrated navigation system 100, such a navigation solution prediction and update process is performed by each sub-filter through the following equations, and the synthesis filter 110 integrates the navigation solutions calculated from each sub-filter to calculate the final navigation solution.

x̅ₖ=Φₖx̅ₖ₋₁+ω̅ₖ [Equation 1]

x̅ₖ=x̅ₖ+Kₖ(zₖ−Hₖx̅ₖ) [Equation 2]

Equation 1 is a navigation solution prediction equation and Equation 2 is an equation for updating a navigation solution. In each equation, x̅ₖ is a predicted state vector or navigation solution (state), \hat{x}ₖ is an updated state vector, Φₖ is a state transition matrix, ω̅ₖ is a process noise vector, Kₖ is a Kalman gain, zₖ is a GNSS pseudorange measurement, and Hₖ is an observation matrix. Such Kalman filter parameters are used to express a calibration statistic formula for fault detection of an IMU sensor, which will be described later.

The present invention proposes a method for detecting a fault of an IMU sensor in a multiple IMUs/GNSS integrated navigation system 100 and a KF-based fault detection apparatus 200 for performing such a method. The IMU sensor fault detection apparatus 200 of the present invention uses the sub-filters of the integrated navigation system 100 as it is, and in each sub-filter, the test statistics are calculated using the pseudorange measurement value of the GNSS sensor and the pseudorange measurement value of each IMU sensor. The fault detection unit 210 calculates the correlation between the calculated test statistics, determines a threshold value of each IMU fault monitor capable of meeting the navigation continuity requirement based on the calculated correlation, and, through comparison of the calculated test statistics and the threshold value, the fault of the IMU sensor is finally detected.

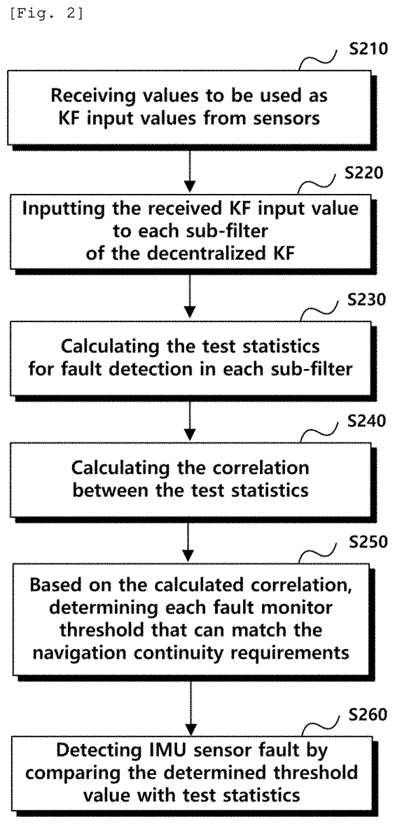

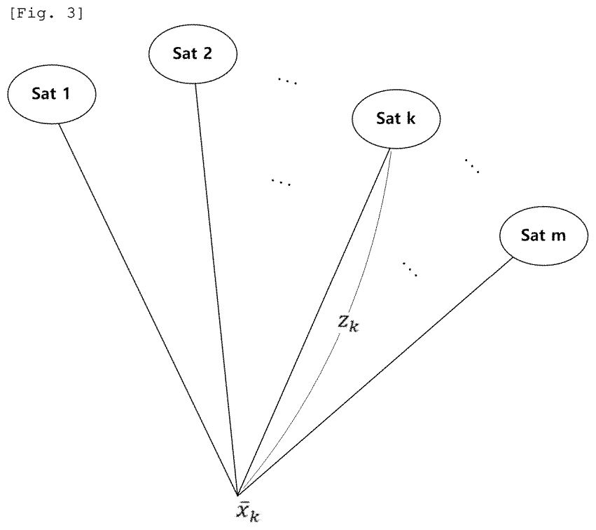

Hereinafter, the fault detection method of the IMU sensor will be described in detail with reference to the flowchart of FIG. 2, but each step of the flowchart will be described in connection with the related drawings in FIGS. 3 to 8.

FIG. 2 is a flowchart of the method for detecting a fault of an IMU sensor for the multiple IMUs/GNSS integrated navigation system 100.

To briefly summarize the flowchart, the IMU sensor fault detection apparatus 200 of the present invention receives a value to be used as an input to the Kalman filter (hereinafter, ‘KF input value’) from the GNSS sensor 10 and the multiple IMU sensors 20 (S210), and the received KF input value is input to each sub-filter 1 to n of the decentralized Kalman filter (S220). When the test statistics for fault detection in each sub-filter is calculated (S230), the fault detection unit 210 calculates the correlation between the calculated test statistics (S240). Based on the calculated correlation, each fault monitor threshold that can match the navigation continuity requirements is determined (S250). IMU sensor fault is detected by comparing the determined threshold value with the sub-filter test statistics (S260).

The KF input value received in step S210 includes the pseudorange measurement value measured by the GNSS sensor 10 (hereinafter, ‘GNSS pseudorange measurement value’) and the IMU sensor measurement value 20. The IMU sensor measurement values include acceleration and angular velocity. Each sub-filter receives GNSS pseudorange measurement value in common and the IMU sensor measurement value measured by the corresponding IMU sensor. Referring to FIG. 1, for example, the measurement value of the IMU 2 sensor is input to sub-filter 2.

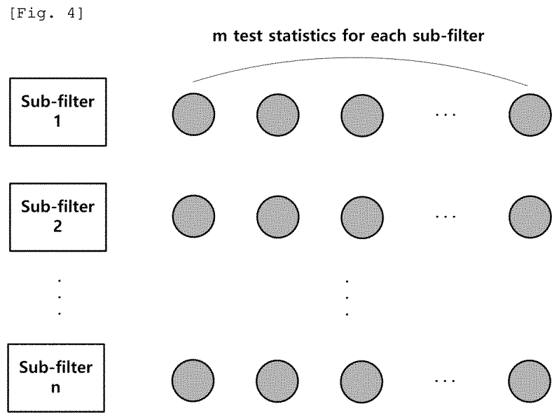

The calculation of the test statistics in step S230 will be described below with reference to FIGS. 3 and 4.

FIG. 3 is a diagram for explaining the parameters of the test statistics used for IMU sensor fault detection of the present invention, and FIG. 4 is a schematic diagram showing the test statistics for a plurality of sub-filters composed of multiple IMU sensors in a decentralized Kalman filter and a plurality of GNSS pseudorange measurements.

The above-mentioned GNSS pseudorange measurement value means that the GNSS sensor 10 measures the distance from the current location with respect to a specific satellite, and the measurement of the distance from the current location with respect to the k-th satellite (Sat k) is denoted by zₖ.

The IMU pseudorange measurement value is a measurement of the distance from the current position with respect to, for example, the k-satellite (Sat k) by using the navigation information x̅ₖ calculated by the sub-filter from the measurement value of the specific IMU sensor 20.

The test statistic of each sub-filter is a Kalman filter innovation vector. The KF innovation vector is calculated as the difference between the GNSS pseudorange measurement value and the pseudorange measurement value predicted by the IMU sensor, and is expressed as Equation 3 below.

\vec{q}ₖ=z_{k,i}−Hₖx̅ₖ [Equation 3]

x̅ₖ is the position, and multiplying this by the observation matrix Hₖ gives the IMU pseudorange measurement.

In the present invention, the fault of the GNSS sensor 10 is independently detected by the GNSS sensor fault monitor, and in the present invention, it is assumed that the fault of the GNSS sensor 10 is not detected. Accordingly, when a fault occurs in the IMU sensor 20, the effect of the IMU sensor fault is included in the test statistics.

Referring to FIG. 4, since the test statistics are calculated for each number (m) of each pseudorange measurement value of the GNSS, the number of test statistics calculated in one sub-filter is m. Since the present invention deals with n sub-filters composed of n multiple IMU sensors, the number of finally calculated test statistics is m·n. Hereinafter, in this case, a module that detects a fault using each test statistic will be referred to as an ‘IMU fault monitor’ of the sub-filter, and m·n number of IMU fault monitors exist.

In the flowchart of FIG. 2, after calculating the test statistics in each sub-filter (S230), the fault detection unit 210 calculates the correlation between the test statistics (S240).

Since each sub-filter shares the same GNSS measurement, a correlation exists between the test statistics calculated in step S230. In this step, the correlation between test statistics is analyzed.

As described above, the correlation considered in the present invention is a correlation generated by sharing the same GNSS measurement value in each sub-filter. Therefore, the correlation takes into account the correlation between the test statistics in different sub-filters using the same GNSS measurement, and does not consider the correlation between the test statistics in the sub-filter consisting of different GNSS pseudorange measurements, assuming that it is very small.

As an example, when there are a total of two sub-filters, the following shows a correlation analysis process between the test statistics in the two sub-filters using the same GNSS pseudorange measurement.

1) In step S230, the test statistics of sub-filter 1 and sub-filter 2 using the same GNSS pseudorange measurement are calculated using Equations 4 and 5.

q_{k,1}=−H_{k,1}Φ_{k,1}\tilde{x}_{k-1,1}+H_{k,1}ω̅_{k-1,1}+vₖ [Equation 4]

q_{k,2}=−H_{k,2}Φ_{k,2}\tilde{x}_{k-1,2}+H_{k,2}ω̅_{k-1,2}+vₖ [Equation 5]

2) Numerical derivation of correlation between two test statistics

The correlation between the two test statistics calculated in 1) is derived as in Equation 6.

E[q_{k,1}q_{k,2}^{T}]=H_{k,1}Φ_{k,1}E[\tilde{x}_{k-1,1}\tilde{x}_{k-1,2}^{T}]Φ_{k,2}^{T}H_{k,2}^{T}+Rₖ[Equation 6]

where,

\tilde{x}_{k,1}=L_{k,1}Φ_{k,1}\tilde{x}_{k-1,1}−L_{k,1}ω̅_{k-1,1}+K_{k,1}vₖ

\tilde{x}_{k,2}=L_{k,2}Φ_{k,2}\tilde{x}_{k-1,2}−L_{k,2}ω̅_{k-1,2}+K_{k,2}vₖ

E[\tilde{x}_{k,1}\tilde{x}_{k,2}^{T}]=L_{k,1}Φ_{k,1}E[\tilde{x}_{k-1,1}\tilde{x}_{k-1,2}^{T}]Φ_{k,2}^{T}L_{k,2}^{T}+K_{k,1}RₖK_{k,2}^{T}.

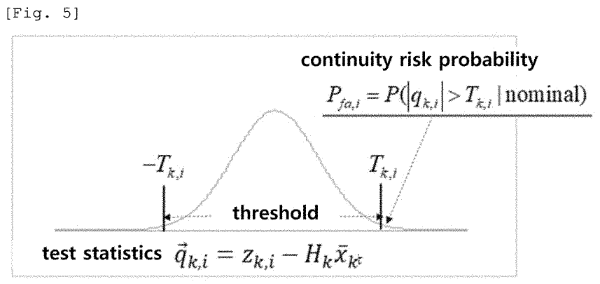

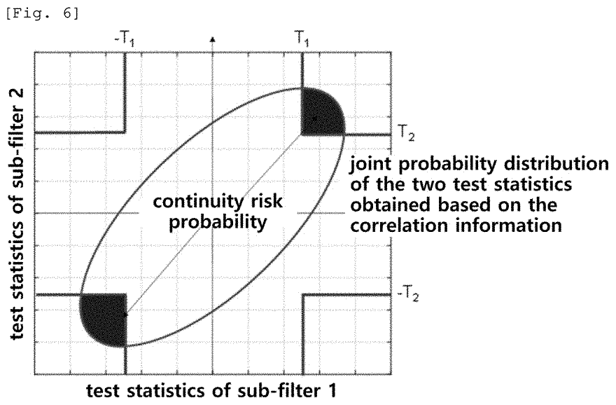

A method of determining a threshold value of each IMU fault monitor capable of meeting the navigation continuity requirement based on correlation in step S250 in the flowchart of FIG. 2 will be described with reference to FIGS. 5 and 6.

FIG. 5 is a diagram for explaining the definition of a continuity risk probability and a threshold value, and FIG. 6 is a diagram for explaining a method of determining a threshold value in each sub-filter to ensure a continuity risk probability.

In order to detect a fault in each m·n IMU failure monitor, it is necessary to determine a threshold value. The IMU fault monitor of the navigation system determines the threshold as a function of the navigation continuity risk probability.

In the navigation system, the probability of continuity risk to be satisfied by navigation is preset. By distributing the preset navigation continuity risk probability to m·n IMU fault monitors, the process of satisfying the final navigation continuity probability of the system is performed. At this time, continuity probabilities are distributed to each monitor based on the correlation between each IMU fault monitor calculated in step S240. The following describes the continuity risk probability distribution process.

First, the continuity risk probability of each IMU failure monitor is defined as shown in FIG. 5. FIG. 5 shows the probability distribution of the test statistic in a state where there is no IMU sensor fault, and the threshold value is determined based on the continuity risk probability in the corresponding probability distribution. In other words, the ‘continuity risk probability’ means the probability that the failure monitor's test statistic exceeds the threshold value and falsely declares a fault under the condition of no fault. As described above, each navigation system sets the upper limit value of this continuity risk probability as a system navigation requirement.

Since one test statistic of a sub-filter means the difference between each GNSS pseudorange measurement value and the pseudorange estimate generated by the IMU sensor, when an IMU sensor fault occurs, it affects all m test statistics of each sub-filter. Therefore, in the case of each sub-filter, if a fault is detected in at least one test statistic out of m, the corresponding IMU sensor is declared as fault. Accordingly, the continuity risk probability in each sub-filter can be expressed as the union of sets indicating whether or not an event in which an abnormality is detected in each of m test statistics as shown in Equation 7 below.

Pᵣ₁=P((FA_{1,1}∪ . . . ∪FA_{1,m})|nominal) [Equation 7]

where, FA_{1,1} ˜FA_{1,m} represent a set indicating whether or not an event occurs in which an abnormality is detected in each of the test statistic in sub-filters 1 to m, and accordingly Pᵣ₁ means the probability that a fault occurred in any one of the m sub-filters.

This system has a total of n sub-filters. In the case of n sub-filters with different IMU sensors, even if one sub-filter declares a fault of the corresponding IMU sensor, a sub-filter with another IMU can be used continuously for navigation. Accordingly, the final continuity risk probability of the system when using n different sub-filters is defined as the intersection of sets indicating whether the IMU corresponding to each sub-filter fails as shown in Equation 8.

Pᵣ=P((Cᵣ₁∩ . . . ∩Cᵣₙ)|nominal) [Equation 8]

where, Cᵣ₁ ˜Cᵣₙ represent a set indicating whether an IMU corresponding to each sub-filter has failed, and accordingly Pᵣ means a probability that all sub-filters will fail.

Based on Equation 8, the threshold value determination process for each IMU fault monitor is performed by distributing the continuity risk probability to each IMU fault monitor based on the correlation between the calculated test statistics of each IMU fault monitor.

FIG. 6 is an example of a continuity probability distribution process. If there are a total of two sub-filters in the system, the joint probability distribution of the two test statistics calculated in the two sub-filters is obtained based on the correlation information calculated in step S240 (the blue solid line distribution). Since the system continuity risk probability is defined as the intersection of the continuity risk probabilities of sub-filter 1 and sub-filter 2 in Equation 8, the threshold is determined so that the continuity risk probability required by the system is the area of the blue-colored area where both test statistics exceed the corresponding threshold.

The shape of the joint probability distribution changes according to the calculated correlation information. For example, in FIG. 6, as the correlation increases, the slope of the distribution increases, and as the correlation decreases, the slope has a low slope. That is, the joint probability distribution varies according to the correlation as described above, and accordingly, the threshold value of each sub-filter at which the area where both test statistics exceed the corresponding threshold becomes the continuity risk probability required by the system also varies depending on the correlation. FIG. 6 shows two sub-filters for easy display in a graph, but the principle is the same even in a system consisting of three or more sub-filters, and the threshold value of each sub-filter that becomes the continuity risk probability required by the system will vary depending on the correlation.

When the threshold value is determined (S250), the IMU sensor fault is detected through comparison of the test statistic calculated in step S230 and the threshold value calculated in step S250. In a situation where the test statistic has a value greater than the threshold value, the IMU sensor fault of the corresponding sub-filter (S260) is declared.

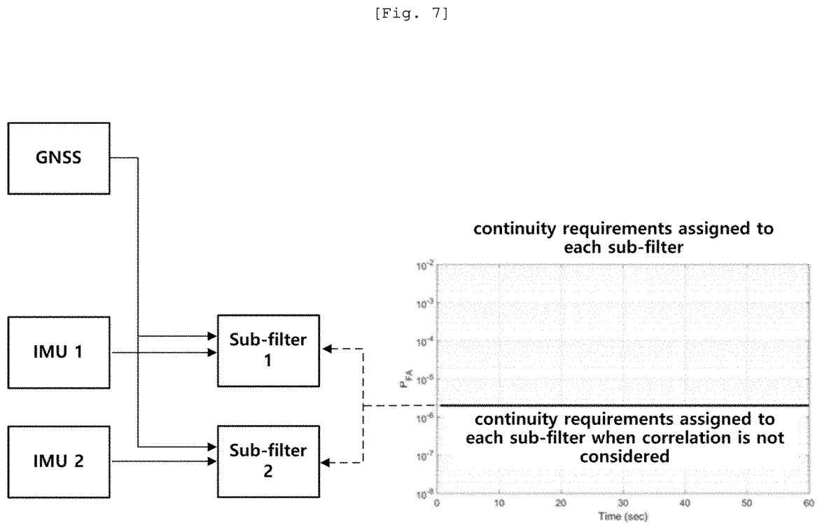

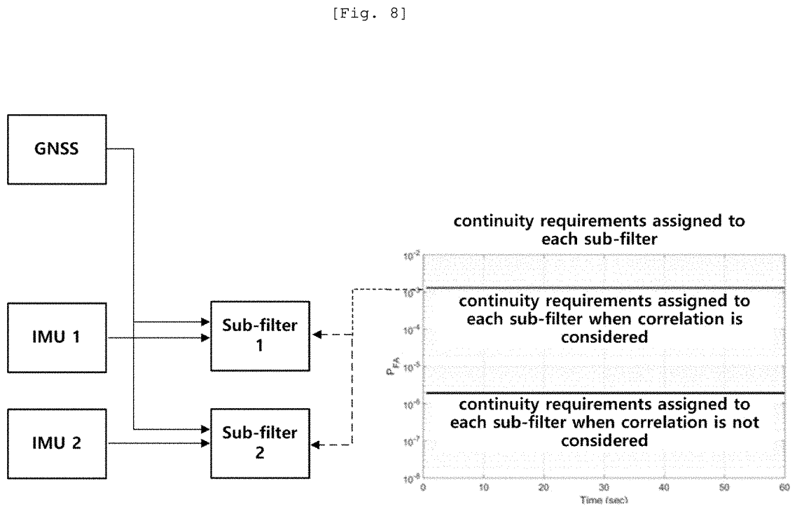

Hereinafter, with reference to FIGS. 7 and 8, a difference between a case in which the correlation for each sub-filter is considered and a case in which the correlation is not considered will be exemplified and described.

FIG. 7 is a diagram illustrating continuity requirements assigned to each sub-filter when correlation is not considered, and FIG. 8 is a diagram illustrating continuity requirements assigned to each sub-filter when correlation is taken into consideration.

Here, the continuity requirement means the probability of judging that a failure has occurred even though there is no failure, that is, the continuity risk probability.

In the case of FIG. 7, correlation is not considered, and it can be seen that the probability of a continuity risk distributed to each sub-filter is very low. A failure with respect to the corresponding sub-filters is to be very sensitively determined, and accordingly, there is a problem in that the availability of each of the sub-filters is deteriorated.

In the case of FIG. 8, correlation is considered, and it can be seen that the red line, that is, the probability of a continuity risk distributed to each sub-filter is high. This means that the probability of determining that the sub-filters are in fault is very low, and it can be seen that the continuity requirements that each sub-filter must satisfy has been relaxed due to the correlation consideration. It directly affects the improvement and contributes to increasing system availability.

What is claimed is:

1. A method for detecting for a fault of an IMU sensor for a multiple Inertial Measurement Units (IMUs) and Global Navigation Satellite System (GNSS) integrated navigation system, comprising the steps of:
(a) receiving values to be used as an input to the Kalman filter (hereinafter, ‘KF input value’) from the GNSS and the multiple IMUs;
(b) inputting the KF input value to each sub-filter of a decentralized Kalman filter;
(c) calculating test statistics for fault detection in said each sub-filter;
(d) calculating correlation between the test statistics;
(e) based on the correlation calculated in the step (d), determining each fault monitor threshold that can match navigation continuity requirements; and
(f) detecting IMU sensor fault by comparing the threshold with the test statistics.

2. The method of claim 1, wherein, in the step (a), the sensors include the GNSS sensor and the multiple IMUs sensors.

3. The method of claim 2, wherein, in step (b), the input of each sub-filter are the pseudorange measurement value of the GNSS sensor (hereinafter, ‘GNSS pseudorange measurement value’) and measurement value of the IMU sensor matched to said each sub-filter.

4. The method of claim 3, wherein the test statistics are difference between the GNSS pseudorange measurement value and an IMU pseudorange measurement value calculated from the measurement value of the IMU sensor.

5. The method of claim 4, wherein, in the step (c), when the number of the sub-filters is n and the number of GNSS pseudorange measurements value input to said each sub-filters is m, the number of the test statistics is m×n.

6. The method of claim 5, wherein, in the step (d), the correlation is a correlation between the test statistics of different sub-filters that utilize same GNSS pseudorange measure value.

7. The method of claim 6, wherein, if a continuity risk probability set in the multiple IMUs and GNSS integrated navigation system is referred to as a system continuity threat probability, in the step (e), when a joint probability distribution of the test statistics of all sub-filters is calculated from the correlation obtained in the step (d) and, according to the joint probability distribution, a probability that the test statistics of all the sub-filters exceed corresponding specific threshold values becomes the system continuity risk probability, each threshold value is determined as a threshold value for each test statistics.

8. The method of claim 7, wherein, in the step (f), when at least one test statistics out of the m test statistics for each sub-filter exceeds the threshold value for the test statistics, determining that the IMU sensor corresponding to the sub-filter has a failure.

9. An apparatus for detecting for a fault of an IMU sensor for a multiple Inertial Measurement Units (IMUs) and Global Navigation Satellite System (GNSS) integrated navigation system, comprising:
at least one processor; and,
at least one memory storing computer-executable instructions,
wherein the computer-executable instructions stored in said at least one memory, when executed by the at least one processor, causes the at least one processor to perform operations comprising:
(a) receiving values to be used as an input to the Kalman filter (hereinafter, ‘KF input value’) from sensors;
(b) inputting the KF input value to each sub-filter of a decentralized Kalman filter;
(c) calculating test statistics for fault detection in said each sub-filter;
(d) calculating correlation between the test statistics;
(e) based on the correlation calculated in the step (d), determining each fault monitor threshold that can match navigation continuity requirements; and
(f) detecting IMU sensor fault by comparing the threshold with the test statistics.
